(19) United States
(12) Patent Application Publication
(10) Pub. No.: US 2024/0391292 A1
(43) Pub. Date: Nov. 28, 2024

(54) COVERS FOR ROOF TOP AIR CONDITION UNITS OF RECREATIONAL VEHICLES

(71) Applicant: Charles C. Williams, Fort Myers, FL (US)

(72) Inventor: Charles C. Williams, Fort Myers, FL (US)

(21) Appl. No.: 18/202,758

(22) Filed: May 26, 2023

(51) Int. Cl. B60H 1/00

(52) U.S. Cl. CPC B60H 1/00364; B60H 1/00507; B60H 1/00514; B60H 2001/00235

(57) ABSTRACT

Novelty customized themed covers and shrouds for rooftop AC units on recreational vehicles which may have forward sloping aerodynamic front ends, two sides having air vents as necessary and a rear end having air exhaust openings. The themes may include without limitation various sport themes, such as racing, football, baseball or other sports, as well as advertising vehicles or any other desired theme.

### BACKGROUND OF THE INVENTION

This invention relates to covers and shrouds for roof top air conditioning units, and more particularly to themed novelty and decorative covers.

Conventional recreational vehicles, hereinafter referred to singularly as “RV”, have an air conditioning (AC) unit attached to a rooftop of the RV. RV air conditioners work on basically the same principle as the cooling units of kitchen refrigerators. In either system a refrigerant extracts heat from inside the RV and dissipates it to the outside. An RV AC should additionally reduce humidity in the air.

The most commonly used AC systems for a RV are compressor systems. In a compressor system, a gaseous refrigerant contained in a closed circuit is pressurized and turned into liquid. The liquid then flows through a pipe system and turns into gas again in the evaporator. In the process it extracts heat from the surrounding environment; the outside of the evaporator cools down. The refrigerant then flows back to the compressor, where the cycle begins again. In this way the air conditioning system dissipates air and cools the vehicle interior. Additionally, it circulates and dehumidifies the room air.

As mounted on a roof of a RV, the AC unit is covered by a shroud that has vents on a front of each side to allow ambient air to be added from the outside for cooling and vents in the rear to allow warm air to be dissipated to the outside. Generally, such AC unit roof top covers are not appealing-looking and not subject to customizing as desired to express one's interest in racing, sports or other interest.

Thus, there is a need for a RV AC unit roof top cover that can supplement or replace a conventional RV AC unit roof top cover or shroud.

### SUMMARY OF THE INVENTION

The primary object of the present invention is to provide a customized RV AC unit roof top cover that can supplement or replace a conventional RV AC unit roof top cover or shroud.

Another object of the present invention is to provide such a customized RV AC unit roof top cover or shroud that is sport-themed.

A further object of the present invention is to provide such a customized RV AC unit roof top cover or shroud that is aerodynamic and functional.

The present invention fulfills the above and other objects by providing a novel and functional customized RV AC rooftop cover or shroud that has a sport-themed appearance, such as a race car, football helmet, ball cap and so forth that can be attached to or even replace a conventional RV roof top AC unit cover or shroud. The present cover or shroud would have vents to allow air floor in and out of the RV so it would f function like a conventional cover or shroud.

The above and other objects, features and advantages of the present invention should become even more readily apparent to those skilled in the art upon a reading of the following detailed description in conjunction with the drawings wherein there is shown and described illustrative embodiments of the invention.

### DESCRIPTION OF THE DRAWINGS

In the following detailed description, reference will be made to the attached drawings in which:

FIG. 1 is a perspective view of a conventional cover or shroud for a RV rooftop AC unit;

FIG. 2 is a side view of an RV with rooftop AC unit covers or shrouds having a race car theme;

FIG. 3 is a side view of an RV with rooftop AC unit covers or shrouds having a football helmet theme;

FIG. 4 is a side view of an RV with rooftop AC unit covers or shrouds having a baseball cap theme; and

FIG. 5 is a side view of an RV with rooftop AC unit covers or shrouds having a general advertising business theme.

### DESCRIPTION OF THE PREFERRED EMBODIMENTS

For purposes of describing the preferred embodiment, the terminology used in reference to the numbered components in the drawings is as follows:
1. RV AC rooftop shroud
2. front of shroud
3. rear of shroud
4a,b. sides of shroud
5. air vents
6. RV
7. race car-themed covers/shrouds
8. front of 7
9. rear of 7
10. venting
11. football helmet covers/shrouds
12. front of 11
13. rear of 11
14. securing bolts/clamps
15. ball cap covers/shrouds
16. front of 15
17. rear of 15
18. securing bolts/clamps
19. advertising vehicle covers/shrouds
20. front of 19
21. rear of 19
22. securing bolts/clamps

Referring to the drawing figures, FIG. 1 illustrates a side view of a conventional RV rooftop AC shroud 1 which covers a typical roof top AC and its components, e.g., compressor, condenser, distribution fans and so forth. The AC shroud 1 has a slightly forward sloping front section 2 for aerodynamic reasons, two sides 4a and b with vents 5 for air intake and a rear section 3 with open back (not shown) for exhausting warm air from the interior of the RV.

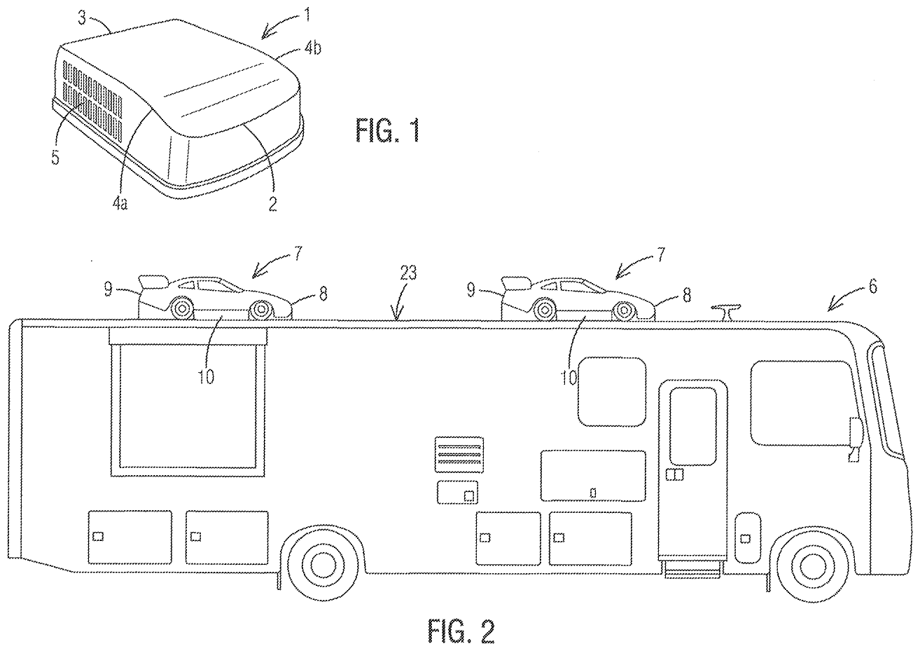

FIG. 2 illustrates a side view of a RV 6 showing rooftop race-car themed AC covers/shrouds 7 having sloping front ends 8 for better aerodynamics, a rear end 9 which is open to exhaust air from the RV and air vents 10 on each side for air intake to the AC unit. The AC covers/shrouds may be secured to the rooftop 23 of the RV by bolts, clamps or other means (not shown).

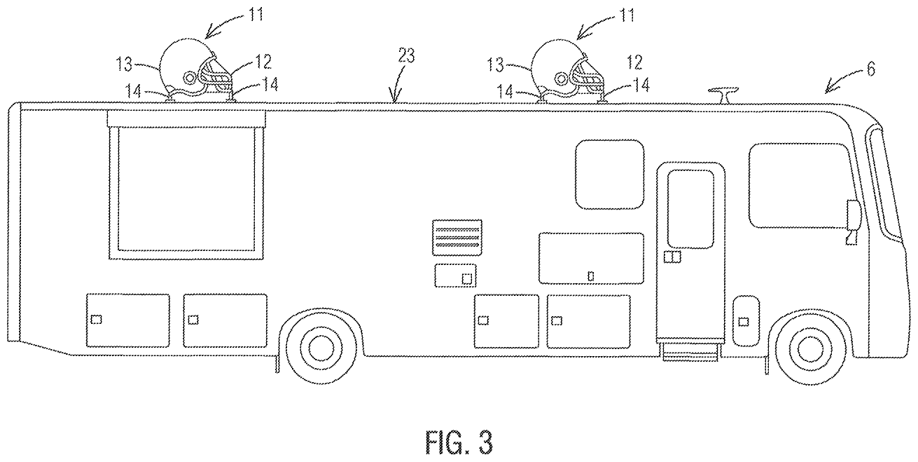

FIG. 3 illustrates a side view of a RV 6 showing rooftop football-themed AC covers/shrouds 11 having sloping front ends 12 for better aerodynamics, a rear end 13 which is open to exhaust air from the RV. The AC covers/shrouds 11 may be secured to the rooftop 23 of the RV by bolts, clamps or other means 14.

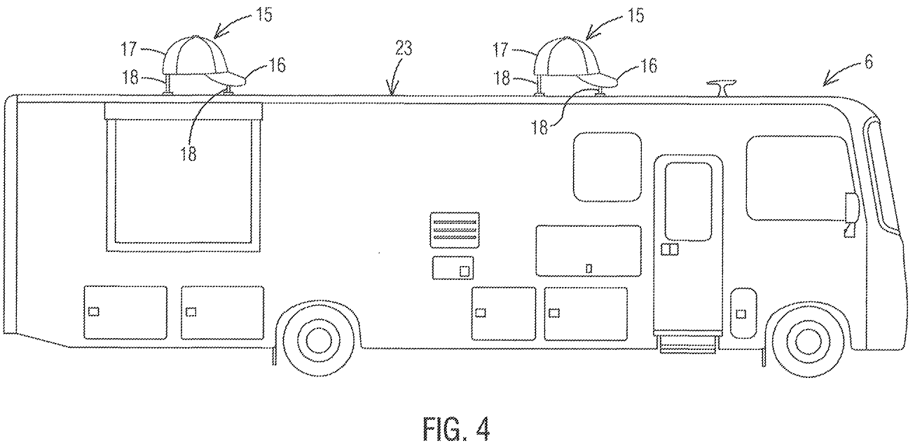

FIG. 4 illustrates a side view of a RV 6 showing rooftop baseball-themed AC covers/shrouds 15 having sloping front ends 16 for better aerodynamics, a rear end 17 which is open to exhaust air from the RV. The AC covers/shrouds 15 may be secured to the rooftop 23 of the RV by bolts, clamps or other means 18.

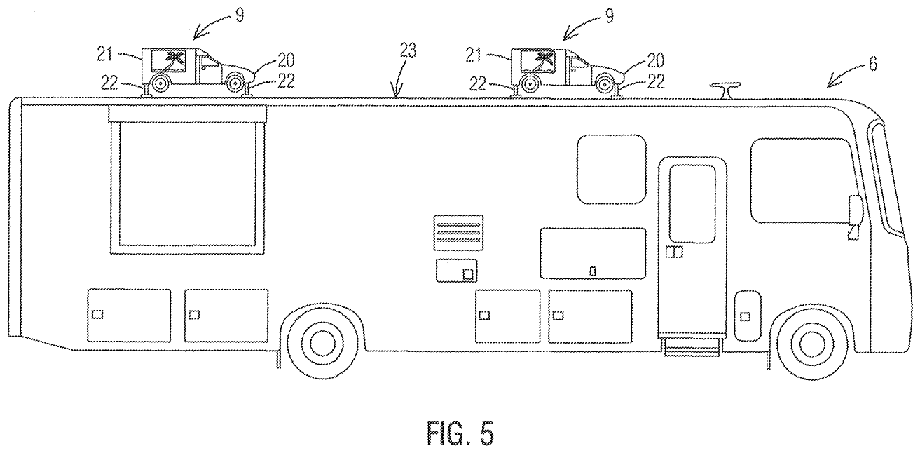

FIG. 5 illustrates a side view of a RV 6 showing advertising vehicle-themed AC covers/shrouds 19 having sloping front ends 20 for better aerodynamics, a rear end 21 which is open to exhaust air from the RV. The AC covers/shrouds 19 may be secured to the rooftop 23 of the RV by bolts, clamps or other means 22.

It is to be understood that while preferred embodiments of the invention have been described, it is not to be limited to the specific form or arrangement of parts herein described and shown. It will be apparent to those skilled in the art that various changes may be made without departing from the scope of the invention and the invention is not to be considered limited to what is shown and described in the specification and/or

Having thus described my invention, I claim:

1. A themed cover for a RV rooftop AC unit, said cover comprising:
the themed cover having a front, two sides and a rear and being sized and shaped to fit on a conventional shroud over the rooftop AC unit; and
means for attaching the cover to the shroud.

2. The themed cover for a RV rooftop AC unit of claim 1 further comprising a forward sloping front for improved aerodynamics.

3. The themed cover for a RV rooftop AC unit of claim 1 further comprising air vents on the two sides.

4. The themed cover for a RV rooftop AC unit of claim 1 having a race car theme.

5. The themed cover for a RV rooftop AC unit of claim 2 having a sports theme.

6. The themed cover for a RV rooftop AC unit of claim 3 having an advertising vehicle theme.

7. A themed shroud for a RV rooftop AC unit, said shroud comprising:
the themed shroud having a front, two sides and a rear and being sized and shaped to fit over the rooftop AC unit; and
means for attaching the cover to the shroud.

8. The themed shroud for a RV rooftop AC unit of claim 7 further comprising a forward sloping front for improved aerodynamics.

9. The themed shroud for a RV rooftop AC unit of claim 7 further comprising air vents on the two sides.

10. The themed shroud for a RV rooftop AC unit of claim 7 having a race car theme.

11. The themed shroud for a RV rooftop AC unit of claim 8 having a sports theme.

12. The themed shroud for a RV rooftop AC unit of claim 9 having an advertising vehicle theme.
